(19) United States
(12) Patent Application Publication
(10) Pub. No.: US 2005/0288062 A1
(43) Pub. Date: Dec. 29, 2005

(54) Method and apparatus for selecting a transmission mode based upon packet size in a multiple antenna communication system

(76) Inventors: Joachim S. Hammerschmidt, Mountain View, CA (US); John P. Veschi, Fogelsville, PA (US)

Correspondence Address: Ryan, Mason & Lewis, LLP, 1300 Post Road, Suite 205, Fairfield, CT, 06824, US

(21) Appl. No.: 10/875,157

(22) Filed: Jun. 23, 2004

(51) Int. Cl. H04M 1/00

(52) U.S. Cl. 455/562.1

(57) ABSTRACT

A method and apparatus are provided for selecting a transmission mode based upon a length of at least a portion of a packet to be transmitted. A packet is transmitted in a multiple antenna communication system by selecting a transmission mode based on a length of at least a portion of the packet. The transmission mode can indicate a number of antennas or date rate (or both) to be used for the transmission. A transmission mode can also be selected based on, for example, (i) a mode selection table that records an expected transmission time for a packet for each supported transmission mode or (ii) one or more packet length thresholds each having a corresponding transmission mode. ACK (acknowledgment) packets can be transmitted using a predefined transmission mode, such as a SISO mode (or a lower order MIMO mode than the original packet), or based on a predefined relationship between the transmission mode of the original packet and the corresponding transmission mode that should be used to acknowledge the packet.

### FIELD OF THE INVENTION

The present invention relates generally to transmission techniques for a wireless communication system, and more particularly, to transmission mode selection techniques for a multiple antenna communication system.

### BACKGROUND OF THE INVENTION

Multiple transmit and receive antennas have been proposed to provide both increased robustness and capacity in next generation Wireless Local Area Network (WLAN) systems. The increased robustness can be achieved through techniques that exploit the spatial diversity and additional gain introduced in a system with multiple antennas. The increased capacity can be achieved in multipath fading environments with bandwidth efficient Multiple Input Multiple Output (MIMO) techniques. A MIMO-OFDM system increases the data rate in a given channel bandwidth by transmitting separate data streams on multiple transmit antennas. Each receiver receives a combination of these data streams on multiple receive antennas.

A MIMO transmission, however, typically requires a longer packet header in order to provide the receiver with sufficient information to estimate various parameters, such as the MIMO channel coefficients. This additional overhead lowers the effective throughput in the MIMO system, especially when the MIMO system has to regularly transmit relatively short packets. In particular, typical WLAN systems acknowledge receipt of each transmission of a packet on the air with a very short “ACK” packet. Thus, the additional overhead related to the MIMO headers may significantly lower the effective throughput in a MIMO system.

A need therefore exists for systems and methods that allow relatively short packets to be transmitted in a MIMO system with reduced overhead and improved throughput.

### SUMMARY OF THE INVENTION

Generally, a method and apparatus are provided for selecting a transmission mode based upon a length of at least a portion of a packet to be transmitted, such as the payload portion of the packet. Thus, a packet is transmitted in a multiple antenna communication system by selecting a transmission mode based on a length of a portion of the packet. The transmission mode can indicate a number of antennas or date rate (or both) to be used for the transmission. In one implementation, a supported transmission mode with a minimum transmission time is selected. In another implementation, a mode selection table is accessed that records an expected transmission time for a packet for each supported transmission mode. In a further variation, a transmission mode can be selected based on one or more packet length thresholds each having a corresponding transmission mode.

ACK (acknowledgment) packets are one example of short packets that can benefit from the present invention. In a static implementation of the present invention, ACK messages are always transmitted using a SISO mode (or a lower order MIMO mode than the original packet). There can optionally be a predefined relationship between the transmission mode that is used to send the original packet and the corresponding transmission mode that should be used to acknowledge the packet.

A more complete understanding of the present invention, as well as further features and advantages of the present invention, will be obtained by reference to the following detailed description and drawings.

### BRIEF DESCRIPTION OF THE DRAWINGS

FIG. 1 illustrates a conventional MIMO-OFDM system consisting of Nₜ transmitters, Nᵣ receivers;

FIG. 2 is a sample table describing exemplary implementations of possible data rate databases for SISO and MIMO systems, respectively;

FIG. 3 illustrates a frame format for a conventional SISO OFDM system;

FIGS. 4A through 4C illustrate exemplary frame formats for a MIMO OFDM system;

FIG. 5 is a schematic block diagram of a MIMO-OFDM transmitter incorporating features of the present invention;

FIG. 6 illustrates the total duration of transmission as a function of the message length for a conventional SISO system and the MIMO system according to FIG. 4A;

FIG. 7 is a sample table describing an exemplary implementation of a transmission mode selection table incorporating features of the present invention; and

FIG. 8 illustrates an exemplary communication exchange between station A and station B in accordance with a static implementation of the present invention.

### DETAILED DESCRIPTION

The present invention provides systems and methods that allow relatively short packets, such as acknowledgement packets, to be transmitted in a MIMO system with reduced overhead and improved throughput. Generally, the present invention selects a lower order antenna configuration, such as a conventional Single Input Single Output (SISO) transmission that employs a single transmit antenna system, when the message to be transmitted is below a predefined packet size. In this manner, the shorter overhead can be exploited for a generally short duration of the transmission, leading to an overall improved system capacity. In one exemplary static implementation, ACK packets acknowledging a MIMO transmission are transmitted in a SISO mode. The approach of the present invention is contrary to an intuitive approach for rate/mode adaptation in a wireless system that would select the highest transmission rate whenever possible. The present invention recognizes that the longer header overheads associated with MIMO communications warrant the use of a lower-rate mode (such as a SISO mode instead of a MIMO mode) despite the channel's possible capability to transmit at a higher rate.

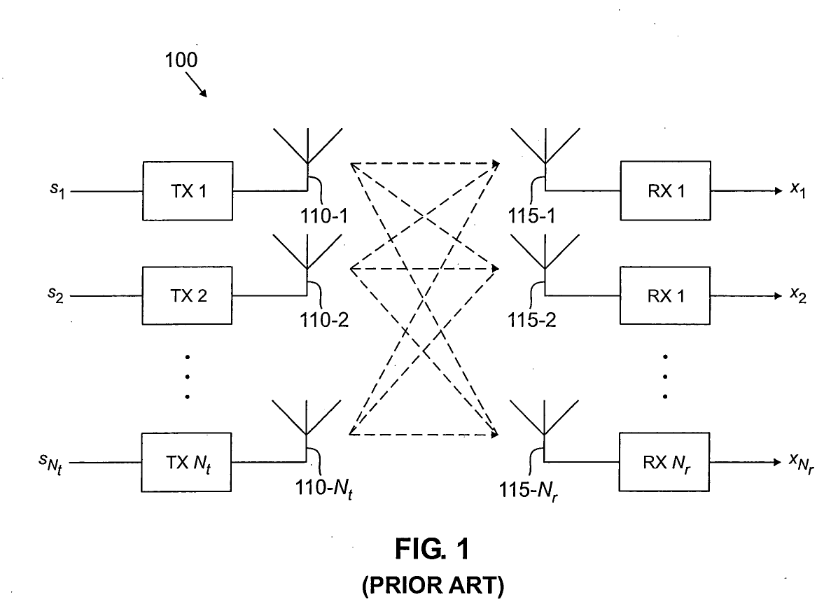

FIG. 1 illustrates an exemplary conventional MIMO-OFDM environment in which the present invention can operate. As shown in FIG. 1, an exemplary conventional MIMO-OFDM system 100 comprises source signals S₁ to S_{Nt}, transmitters TX₁ to TX_{N}_{ₜ}, transmit antennas 110-1 through 110-Nₜ, receive antennas 115-1 through 15-Nᵣ, and receivers RX₁ to RX_{N}_{ᵣ}. The MIMO-OFDM system 100 transmits separate data streams on the multiple transmit antennas 1 10, and each receiver RX receives a combination of these data streams.

As used herein, the term “SISO” shall mean a system that transmits a single data stream (“signal layer”) into a channel. The term “SISO” may include a system that employs two transmit antennas that transmit essentially the same signal, for example, in a beamforming or transmit diversity type of configuration; and a system that employs multiple receive antennas (such as in a receive diversity/beamforming type of configuration). In addition, the term SISO may be used to describe a system with a single transmitter but multiple receive antennas-. Thus, in our terminology, the term “SISO” captures all systems that have a single transmit layer in the same channel bandwidth, regardless of how the signal is actually generated and regardless of how the receiver “samples” the wireless medium with one or several receive antennas. Similarly, as used herein, the term “MIMO” shall mean a system in which there are multiple transmission layers, i.e., several distinguishable streams are transmitted from different antennas into the same frequency channel. It is noted that there could be one or more receive antennas in various configurations to receive such a MIMO transmission. In typical implementations for rate enhancement, there will be as many receive antennas as transmit antennas, or more receive antennas than transmit antennas.

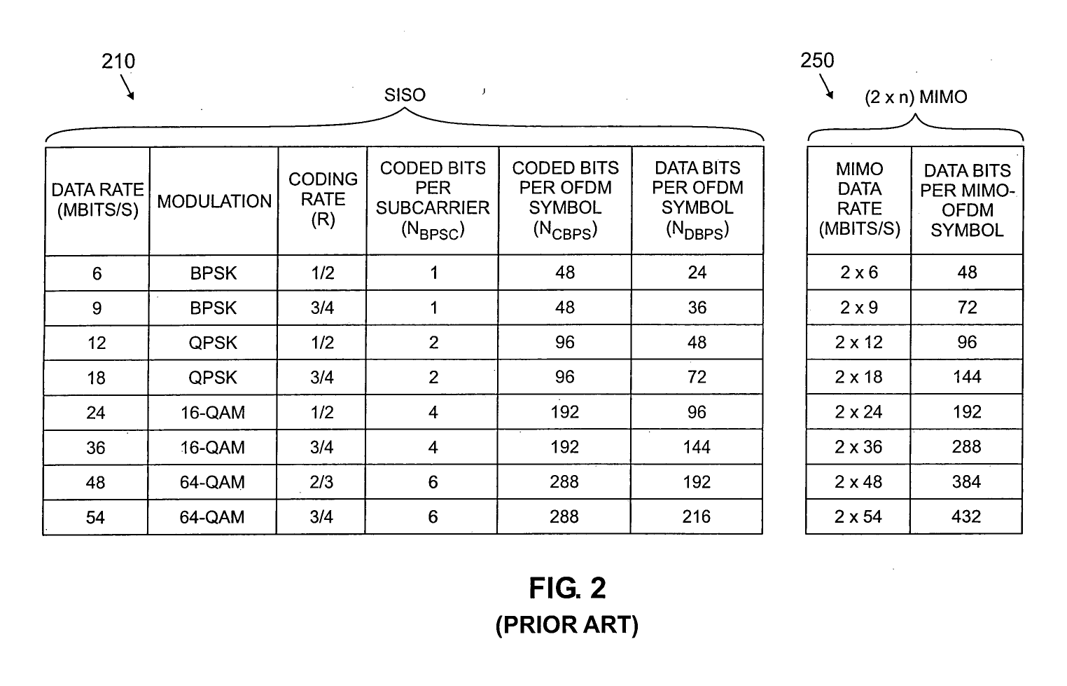

FIG. 2 is a sample table describing exemplary implementations of possible data rate databases 210, 250 for SISO and MIMO systems, respectively. The SISO possible data rate database 210 includes a record for each supported data rate. For each supported data rate, the possible data rate database 210 indicates the system properties in terms of coding and QAM-modulation, in accordance with the 802.11a/g specification.

The MIMO possible data rate database 250 includes a record for each supported data rate, assuming two transmit antennas. For each supported data rate, in an exemplary implementation, the possible data rate database 250 assumes the same system properties in terms of coding and QAM-modulation, in accordance with the 802.11a/g specification. Thus, as shown in the final column of each table in FIG. 2, the MIMO system typically provides twice as many data bits per MIMO-OFDM symbol as the SISO system.

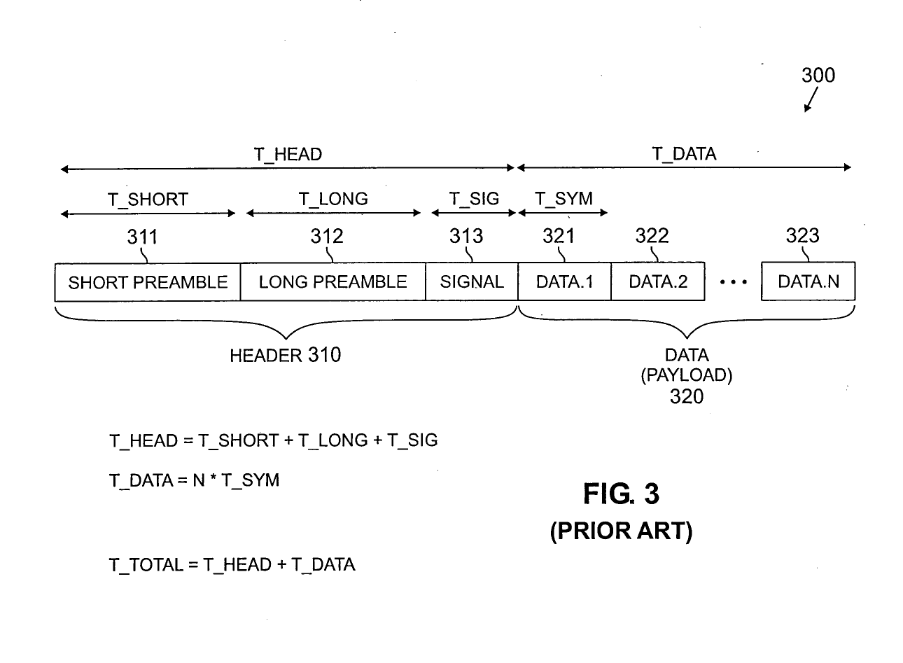

FIG. 3 illustrates a frame format 300 for a conventional SISO OFDM system. As shown in FIG. 3, the frame format 300 includes a header section 310 and a payload section 320. The header section 310 includes a “Short Preamble” period 311, a “Long Preamble period 312 and a signal 313. The short preamble 311 is generally 8 microseconds long, consisting of 10 Short Preambles in the exemplary 802.11g/a system. The short preamble 311 is used by a receiver to detect that there is a packet coming in and to adjust the Automatic Gain Control in the radio circuit. The “Long Preamble” period 312 generally contains two long preambles in the exemplary 802.11g/a system. The long preamble 312 is used by a receiver to estimate various parameters, such as channel estimation, frequency offset and timing synchronization. The signal field 313 contains information of the physical layer properties of the frame, for example, to indicate the data rate and packet length to the receiver. The payload section 320 carries the actual information useful to the MAC layer.

As shown in FIG. 3, the overall duration of transmitting a packet is given by the addition of the header duration T_head plus the data duration T_data. As previously indicated, the present invention recognizes that for packets having a data length below a predefined threshold, a lower-rate mode (such as a SISO mode instead of a MIMO mode) should be employed to reduce overhead and improve the throughput.

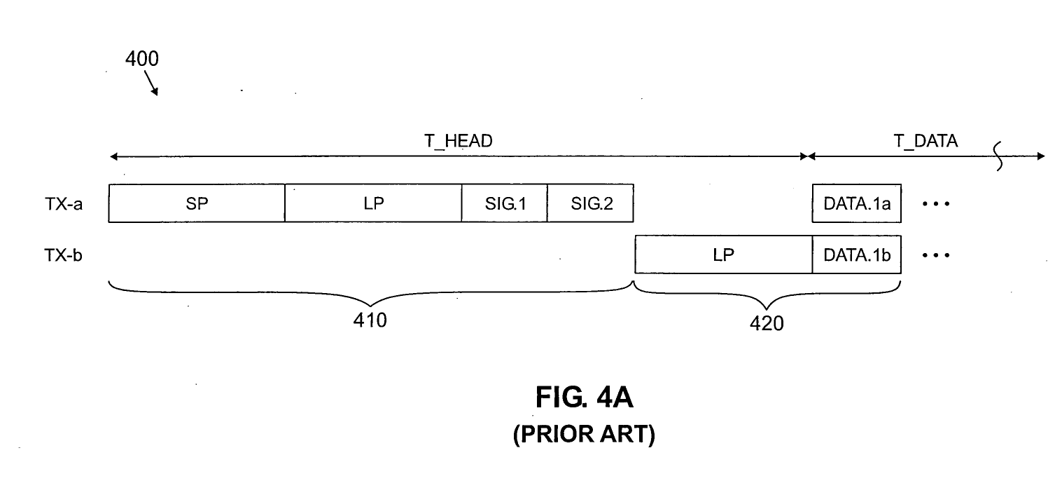

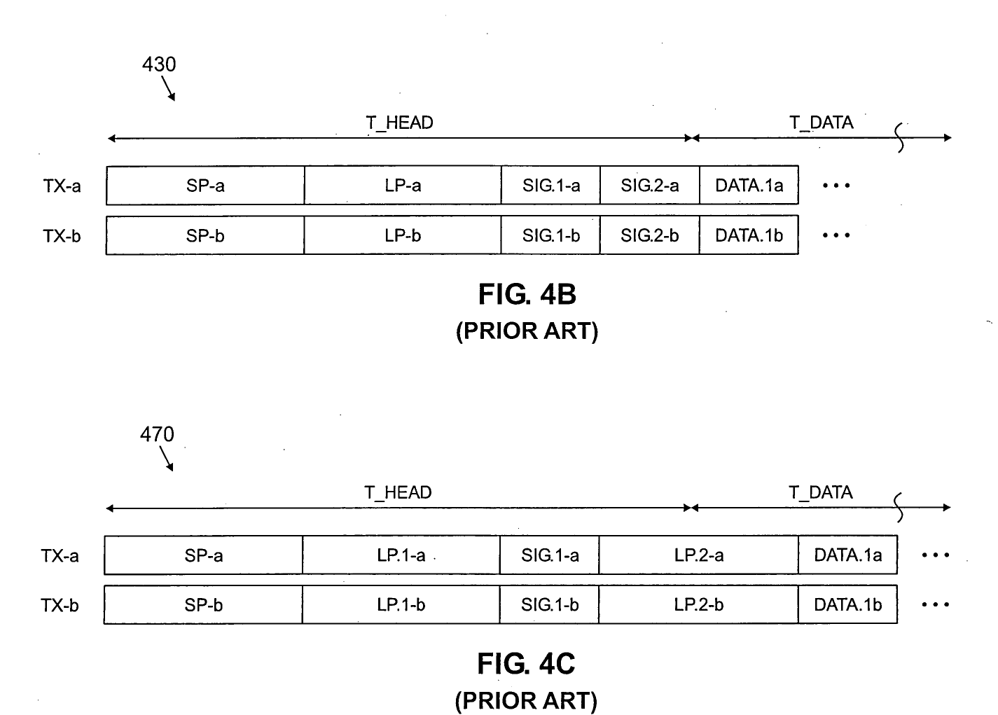

FIGS. 4A through 4C illustrate exemplary frame formats 400, 430, 470 for a MIMO OFDM system. In the examples of FIGS. 4A through 4C, the first row (Tx-a) shows the signal transmitted from a first transmit (Tx) antenna, whereas the second row (Tx-b) is for a 2^{nd} Tx antenna. As shown in FIG. 4A, for example, the frame format 400 includes a header section 410 and a payload section 420. The header section 410 includes a short preamble (SP) period, a long preamble (LP) period and two signal fields. In addition, the data section 420 includes a second long preamble (LP) period for the second antenna and two data fields (one for each of two antennas). In other words, in FIG. 4A, antenna Tx-a transmits a regular header, followed by a second signal field (containing, e.g., additional rate/packet-length/coding information for the more complex MIMO format), then followed by a Long Preamble transmitted from the 2^{nd} antenna. After that, data is transmitted in parallel (MIMO mode) simultaneously from the two antennas Tx-a and Tx-b. FIGS. 4B and 4C employ different MIMO preamble techniques with additional signal and/or preamble fields. Further variations of the exemplary frame formats 400, 430, 470 are possible, as would be apparent to a person of ordinary skill in the art.

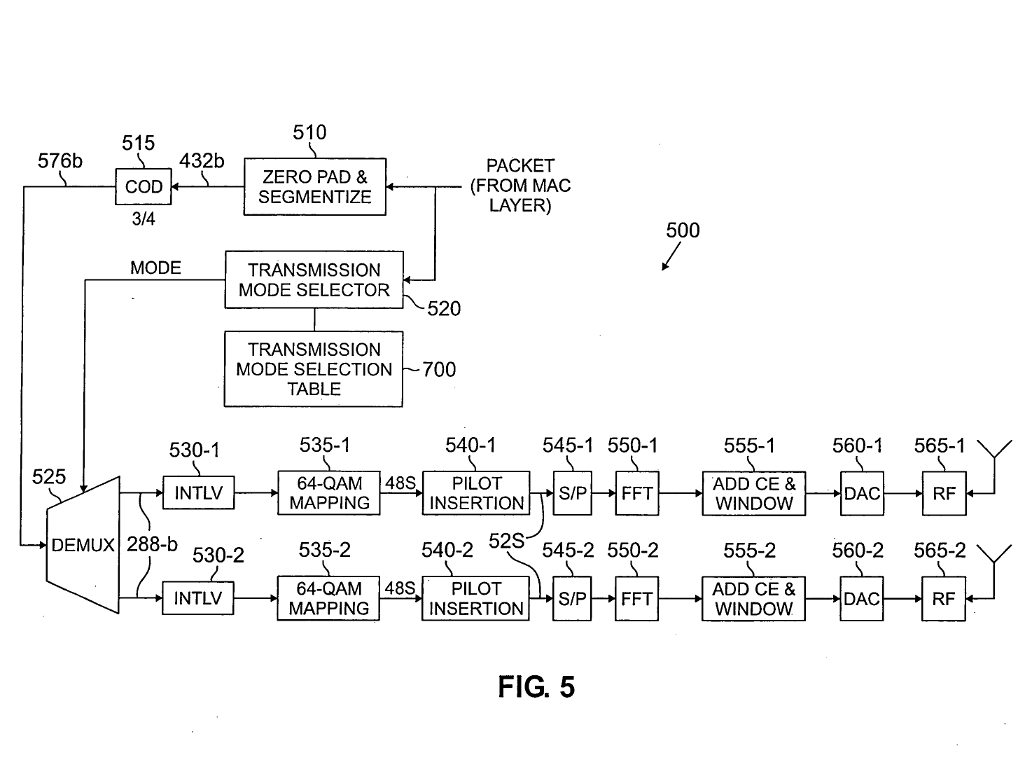

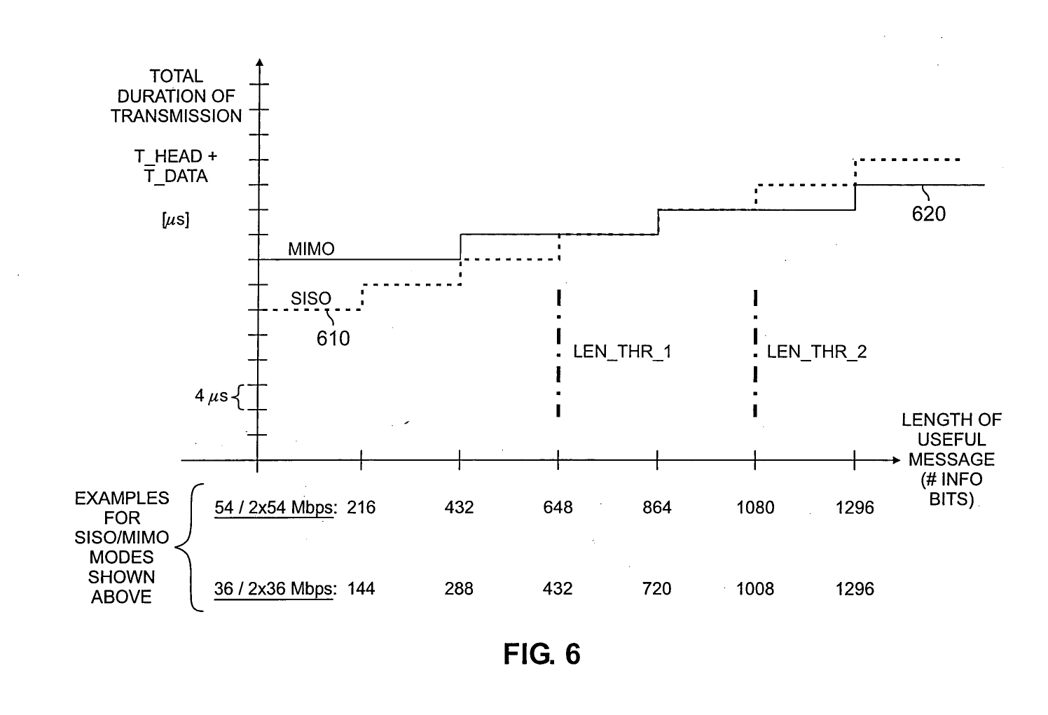

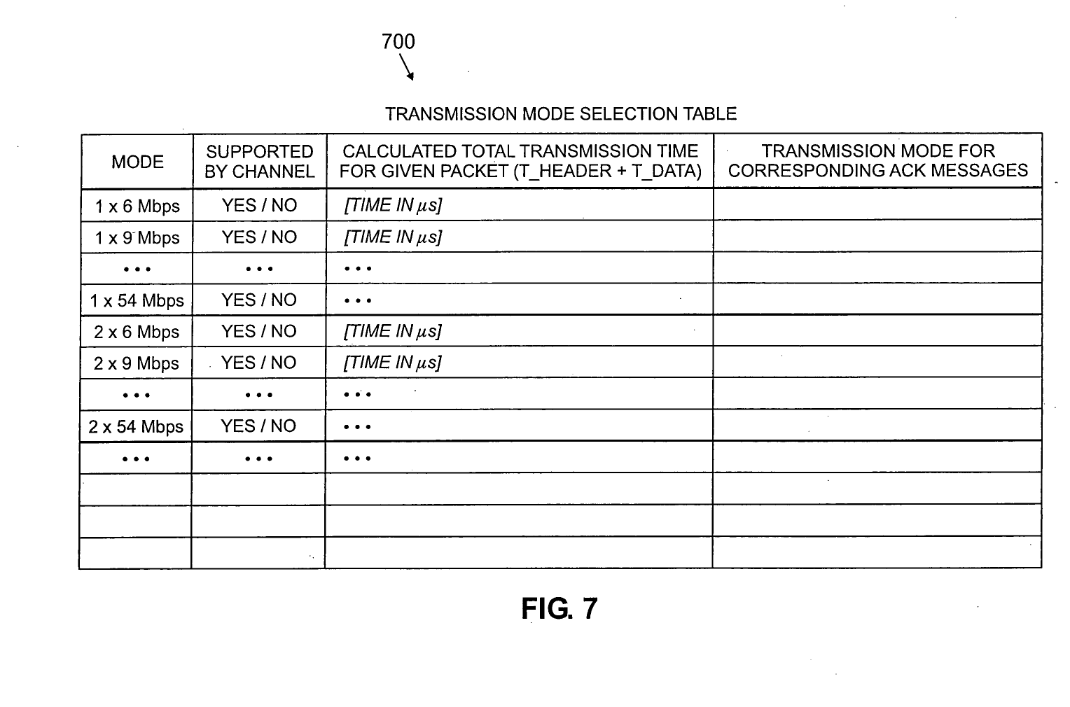

As apparent from the exemplary frame formats 400, 430, 470 shown in FIGS. 4A through 4C, the header for a MIMO system will be longer than that of a corresponding SISO system. According to one aspect of the invention, a transmitter selects a supported mode with the lowest transmission time. In one embodiment, discussed below in conjunction with FIGS. 5 and 7, a mode selection table 700 is employed to record an expected transmission time for a packet for each supported mode. In this manner, the supported mode with the lowest expected transmission time can be selected for a packet. In a further variation, one or more packet length thresholds can be established each having a corresponding transmission mode to employ for a packet in a given size range. In yet another implementation, a SISO mode (or lower order MIMO mode) can be employed to send ACK (Acknowledge) messages. There can optionally be a predefined relationship between the transmission mode that is used to send a packet and the corresponding transmission mode that should be used to acknowledge the packet. For example, as discussed further below in conjunction with FIG. 6; the transmission mode selection table 600 can optionally indicate a transmission mode for ACK messages that should be employed whenever a packet is received that has been transmitted using a given transmission mode.

FIG. 5 is a schematic block diagram of a MIMO-OFDM transmitter 500 incorporating features of the present invention. As previously indicated, in a MIMO-OFDM system, the data from the MAC is encoded and demultiplexed in order to be transmitted simultaneously from several transmit branches using the same channel bandwidth. As shown in FIG. 5, the MIMO-OFDM transmitter 500 receives a packet from the MAC layer. Each packet is segmented and padded with any necessary zeroes at stage 510, encoded at stage 515 and demultiplexed at stage 525 for transmission on a plurality of transmit branches. The transmission mode employed by the demultiplexer 525 is discussed further below. In the exemplary embodiment of FIG. 5, the MIMO-OFDM transmitter 500 employs two transmit branches. The demultiplexed data is optionally interleaved at stage 530 and QAM-modulated at stage 535. Pilot insertion is performed at stage 540 and the data is parallelized at stage 545. The parallel data is FFT-modulated at stage 550. A Cyclic Prefix CP (or Guard Interval, GI), is added at stage 555 and converted to an analog signal at stage 560. The RF stage 565 transmits the signal on a corresponding antenna.

According to one aspect of the present invention, the MIMO-OFDM transmitter 500 also includes a transmission mode selector 520 and a transmission mode selection table 700, discussed further below in conjunction with FIG. 7. The transmission mode selection table 700 indicates, for each potential transmission mode, whether the mode is supported by the transceiver, as well as the expected total transmission time for given packet using the mode. The transmission mode selector 520 can select one eligible mode from the transmission mode selection table 700, for example, that provides the minimum transmission time. For example, the selected mode may indicate the number of active transmit branches and encoding rate. In a further variation, the transmission mode selector can compare the length of the received packet to one or more predefined thresholds, each having a corresponding transmission mode, in order to select an appropriate transmission mode.

FIG. 6 illustrates the total duration of transmission (for example, in microseconds) as a function of the message length (for example, in terms of number of information bits) 610, 620, for a conventional SISO system and the MIMO system according to FIG. 4A, respectively. It is noted that a system can only transmit an integer number of OFDM data symbols, leading to the stair-case shaped dependency between the number of information bits and the packet duration, as shown in FIG. 6. Thus, whenever the number of information bits crosses a certain threshold, a whole OFDM symbol will be added, although it might carry only a very small amount of useful information. This effect is unavoidable with OFDM modulation. For longer packets composed of tens or even a few hundred OFDM data symbols, this edge effect is usually negligible. The present invention recognizes, however, that shorter packets can be transmitted with reduced overhead and improved throughput using a lower order transmission mode.

As shown in FIG. 6, the horizontal axis indicates the number of information bits (MAC packet length) to be transmitted, and the vertical axis indicates the overall predicted duration of transmission on the air (including both the overhead from the header T_head and the payload duration T_data). The exemplary units on the vertical axis are in multiples of one conventional OFDM symbol, i.e., 4 microseconds. The exemplary units on the horizontal axis depend on the actual data rates (modes) employed. For instance, following the example numbers discussed above in conjunction with FIG. 2, each unit on the horizontal axis could correspond to a segment of 432/2 (216 bits), which in the SISO case using 3/4 rate coding and 64-QAM modulation is coded into 288 bits and transmitted on one OFDM symbol.

In a two-dimensional MIMO implementation, as shown in the table 250 of FIG. 2, again using 3/4 rate coding and 64-QAM, each segment of 216 information bits would correspond to the 288 bits transmitted from one of the transmit antennas in one MIMO-OFDM symbol. In this MIMO setup, each increase of the information length by 2×216 (432) bits (or a fraction therefore) would lead to an increase of the transmission duration by one MIMO-OFDM symbol, whereas in SISO, the granularity is 216 bits. A total length of 217 bits, for instance, would have to be transmitted as 2 SISO-OFDM symbols.

As shown in FIG. 6, due to the extra overhead in the training part of the MIMO header, the SISO system outperforms the MIMO system in terms of overall transmission time up to a certain threshold Len_THR_1. Between the thresholds Len_THR_1 and Len_THR_2, the two systems are equally efficient, and after Len_THR_2, the MIMO system is more efficient than the SISO system. Therefore, even when the channel would support a very high-speed MIMO transmission, in the case of very short packets (i.e., packets having a length below Len_THR_1), conventional SISO should be used.

In one exemplary embodiment, selection of a transmission mode can be achieved using a table. FIG. 7 is a sample table describing an exemplary implementation of a transmission mode selection table 700 incorporating features of the present invention. As shown in FIG. 7, the transmission mode selection table 700 includes a plurality of records, each associated with a different potential transmission mode. For each potential transmission mode, the transmission mode selection table 700 indicates whether the mode is supported by the transceiver, as well as the expected total transmission time for given packet using the mode. In a further variation, the transmission mode selection table 700 also indicates a transmission mode for an ACK message for each potential transmission mode.

Thus, for each possible transmission mode (e.g., SISO rates from 6 Mbps to 54 Mbps according to 802.11g/a, as well as MIMO rates exhibiting multiples of the SISO rates or other rates defined in the MIMO specifications), the table indicates whether the wireless propagation channel currently supports this data rate (these are the “eligible” rates) and, for the current packet coming in from the MAC to be transmitted over the air, an entry stating the time it would take to transmit the packet using the respective mode. Typically, the MAC layer knows which rates the channel supports based on previous (successful or failed) transmission attempts. The second entry only needs to be calculated for the eligible modes that are supported by the channel. The final column in the transmission mode selection table 700 indicates the transmission mode that a receiver should use to acknowledge a received packet, for each potential transmission mode.

The system can then select one eligible mode from the transmission mode selection table 700 that guarantees a minimum transmission time. In the above example, if a two-dimensional MIMO-OFDM mode using 3/4 rate coding, 64-QAM modulation and the corresponding SISO-OFDM mode were eligible and the incoming packet were smaller than Len_THR_1, the SISO-OFDM mode would be selected from the table 700 due to its better efficiency.

In a further variation of the mode selection table 700, the table 700 can contain a record for various packet length thresholds and a corresponding indication of the mode that should be used for each packet length range. In yet another variation of the mode selection table 700, the entries in the table 700 can be dynamically populated with the available rates according to a rate fallback scheme. For a detailed discussion of a suitable rate fallback mechanism, see, for example, U.S. patent application Ser. No. 10/670,747, filed Sep. 25, 2003, entitled “Method and Apparatus for Rate Fallback in a Wireless Communication System,” incorporated by reference herein.

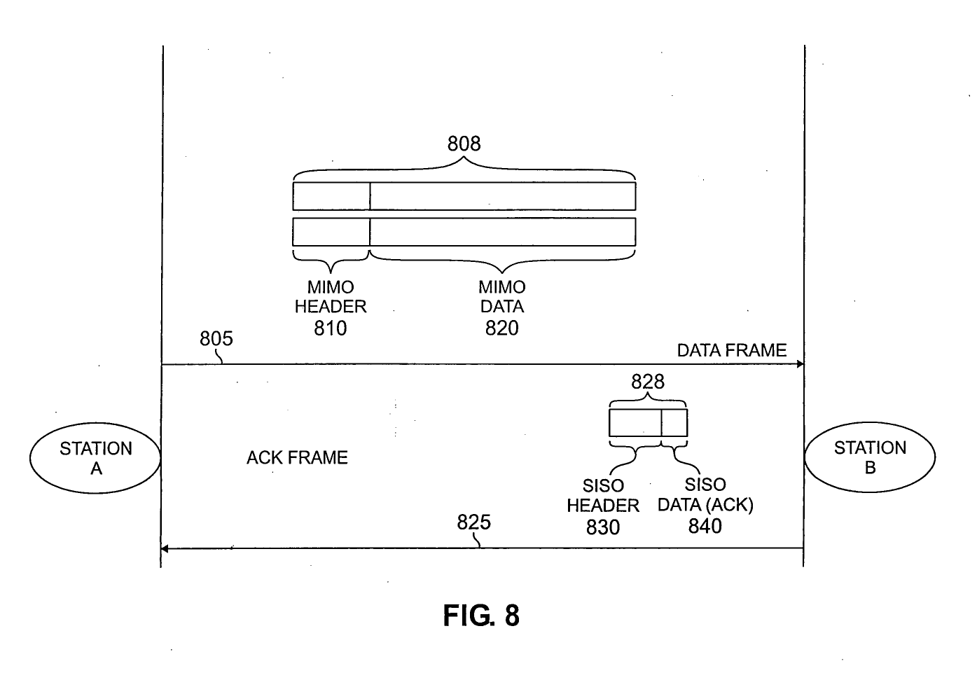

As previously indicated, ACK (acknowledgment) packets are one example of very short packets that are dominant in any WLAN communication scenario, such as those that implement the 802.11 standard. ACK packets are required to confirm receipt of any packet transmitted from a station A to a station B. FIG. 8 illustrates an exemplary communication exchange between station A and station B in accordance with a static implementation of the present invention. In an exemplary static implementation of the present invention, all packets are transmitted using a MIMO mode and the shorter ACK messages are transmitted using a SISO mode (or lower order MIMO mode). There can optionally be a predefined relationship between the transmission mode that is used to send a packet and the corresponding transmission mode that should be used to acknowledge the packet.

As shown in FIG. 8, for example, all packets 808 transmitted from station A to station B on a wireless channel 805 are communicated using a MIMO mode. The packets 808 are comprised of a header portion 810 and a payload (data) portion 820. The shorter ACK message 828 transmitted from station B to station A on the wireless channel 825 to acknowledge receipt of the packet 808 is communicated using a SISO mode. The ACK message 828 is comprised of a header portion 830 and a payload (data) portion 840.

### EXAMPLES

ACKs typically have a length of only 14 bytes (or 112 bits). Thus, an ACK message fits into a single SISO-OFDM symbol for the data rate modes 36, 48, and 54 Mbps, and into two SISO-OFDM symbols for the data rates 18 Mbps to 24 Mbps (assuming no additional overhead), according to the SISO table 210 of FIG. 2 (rightmost column). At SISO rates of 12, 9, and 6 Mbps, a total number of three, four, and five OFDM-symbols will be needed, respectively. On the other hand, for MIMO transmissions, assuming a two-dimensional MIMO system (two Tx antennas) using the same underlying channel coding and QAM-modulation structure as in the above example, the MIMO data rate modes for which a single MIMO-OFDM symbol captures the 112 ACK-bits are the rate modes ranging from 2×18 Mbps to 2×54 Mpbs. Moreover, for the lower rate MIMO-OFDM modes shown in table 250 of FIG. 2, except for the 2×6 Mbps mode, the ACK fits into two MIMO-OFDM symbols. Generally, the 112 bit ACK message will fit into three MIMO-OFDM symbols for any MIMO rate from the table 250.

In a typical scenario, assume that if the channel supports a certain legacy (SISO) rate of R Mpbs (R equals 6 to 54), the channel may also support the corresponding MIMO rate of n×R Mbps (n being the number of transmit dimensions, e.g., 2) in many cases. (This depends on the actual propagation environment). The comparison in terms of total packet duration is therefore as illustrated in FIG. 6 (refer to the numbers in information bits at the bottom of FIG. 6 to examine the specific examples 54 Mbps versus 2×54 Mbps, and 36 Mbps versus 2×36 Mbps). Based on the foregoing discussion, for up to three information bit length units (ticks on horizontal axis), the SISO system outperforms the MIMO system. In both these examples (36/2×36 and 54/2×54), one symbol is always enough to transmit the 112-bit ACK. Therefore, the SISO mode should be used for the Acknowledgment, although the channel would support a higher MIMO rate.

In other scenarios, where the above assumption of rates between SISO and MIMO modes supported by the channel is more involved, the mode selection table 700 approach from FIG. 7 will indicate the mode that should be used.

It is noted that although the present invention has been explained for the exemplary MIMO case with two transmit dimensions, the invention also applies to high-dimensional MIMO systems such as those having three or more transmit antennas in the same way, as would be apparent to a person of ordinary skill in the art. For short packets, a SISO mode will outperform a MIMO mode and despite the possible capability of the channel to support a higher rate MIMO mode, a SISO mode (or lower order MIMO mode, if appropriate) should be used.

It is further noted that if a certain system-setup is MIMO capable but chooses to use a SISO transmission, the receiver will typically be able to use the multiple receive antenna branches (otherwise used for separation of MIMO signal layers) to perform receive diversity. This usually considerably improves the reception quality, allowing the transmitter in a SISO mode to use a higher data rate on average. Using a higher rate leads to fewer data symbols to be transmitted, such that the overall transmission time decreases. A typical MIMO receiver would automatically use receive diversity (i.e., go into an effective “SIMO” mode) if the receiver discovers at the beginning of a packet that the packet is a legacy SISO transmission. Due to the higher possible average data rates, the number of SISO OFDM symbols will be reduced, lowering the total transmission time even further.

For example, a system that uses a 2×24 Mbps MIMO transmission for long packets might not switch to a 1×24 Mbps SISO mode for the ACK, but, e.g., be able to go up to 1×36 or 1×54 SISO modes for that purpose. This reduces the amount of SISO-OFDM data symbols required to transmit the 112 bits of data from two to one, further reducing the overall duration of the transmission. This optimization of modes/rates is best administered for the general case by using the mode selection table 700 discussed above in conjunction with FIG. 7.

It is to be understood that the embodiments and variations shown and described herein are merely illustrative of the principles of this invention and that various modifications may be implemented by those skilled in the art without departing from the scope and spirit of the invention.

1. A transmission method in a multiple antenna communication system, said method comprising the step of:
selecting a transmission mode based on a length of at least a portion of one or more packets to be transmitted.

2. The method of claim 1, wherein said at least a portion of one or more packets to be transmitted is a payload portion of said one or more packets to be transmitted.

3. The method of claim 1, wherein said selecting step further comprises the step of selecting a supported transmission mode with a minimum transmission time.

4. The method of claim 1, wherein said selecting step further comprises the step of selecting a supported transmission mode with a shorter length header as the length of the payload portion of the packet to be transmitted decreases.

5. The method of claim 1, wherein said selecting step further comprises the step of accessing a mode selection table that records an expected transmission time for a packet for each supported transmission mode.

6. The method of claim 1, wherein said selecting step further comprises the step of comparing the length of the at least a portion of the packet to be transmitted to one or more thresholds, each threshold corresponding to a different transmission mode.

7. The method of claim 1, wherein said selecting step further comprises the step of selecting a transmission mode for sending an acknowledgement (ACK) to a received packet, wherein said selected transmission mode for said ACK is based on a transmission mode that is used to send said received packet.

8. The method of claim 1, wherein said step of selecting a transmission mode is further based on a whether a given transmission mode is supported by a channel.

9. The method of claim 1, wherein said selecting step further comprises the step of selecting a lower order MIMO transmission mode.

10. The method of claim 9, wherein said lower order MIMO transmission mode is used to send an ACK message.

11. The method of claim 1, wherein said selecting step further comprises the step of selecting a SISO transmission mode.

12. The method of claim 11, wherein said SISO transmission mode is used to send an ACK message.

13. The method of claim 1, further comprising the step of determining the number of antennas to use for transmitting a signal based upon the selected transmission mode.

14. The method of claim 13, further comprising the step of transmitting the one or more packets over the determined number of antennas.

15. The method of claim 1, wherein said transmission mode indicates a data rate to use for said transmission.

16. The method of claim 1, wherein the selecting step further comprises the step of selecting between at least a first mode and a second mode, wherein in the first mode a payload portion is transmitted with a header having a first length and wherein in the second mode a payload portion is transmitted with a header having a second length that differs from the first length.

17. A transceiver for transmitting a packet in a multiple antenna communication system, said transceiver comprising:
a transmission mode selector that selects a transmission mode based on a length of at least a portion of said packet.

18. The transceiver of claim 17, further comprising a memory that stores a mode selection table that records an expected transmission time for a packet for each supported transmission mode.

19. The transceiver of claim 18, wherein said transmission mode selector accesses said mode selection table to select a supported transmission mode.

20. The transceiver of claim 17, wherein said transmission mode indicates a number of antennas to use for said transmission.

21. The transceiver of claim 17, wherein said transmission mode indicates a data rate to use for said transmission.

22. The transceiver of claim 17, wherein said at least a portion of one or more packets to be transmitted is a payload portion of said one or more packets to be transmitted.

23. The transceiver of claim 17, wherein said transmission mode selector selects a supported transmission mode with a minimum transmission time.

24. The transceiver of claim 17, wherein said transmission mode selector selects a supported transmission mode with a shorter length header as the length of the payload portion of the packet to be transmitted decreases.

25. The transceiver of claim 17, wherein said transmission mode selector compares the length of the at least a portion of the packet to be transmitted to one or more thresholds, each threshold corresponding to a different transmission mode.

26. The transceiver of claim 17, wherein said transmission mode selector selects a transmission mode for sending an acknowledgement (ACK) to a received packet, wherein said selected transmission mode for said ACK is based on a transmission mode that is used to send said received packet.

27. The transceiver of claim 17, wherein said transmission mode selector selects said transmission mode based on a whether a given transmission mode is supported by a channel.

28. The transceiver of claim 17, wherein said transmission mode selector selects a lower order MIMO transmission mode.

29. The transceiver of claim 17, wherein said transmission mode selector selects a SISO transmission mode.

30. The transceiver of claim 17, wherein said transmission mode selector determines a number of antennas to use for transmitting a signal based upon the selected transmission mode.

31. The transceiver of claim 17, wherein said transmission mode selector selects a data rate to use for said transmission.

32. The transceiver of claim 17, wherein said transmission mode selector selects between at least a first mode and a second mode, wherein in the first mode a payload portion is transmitted with a header having a first length and wherein in the second mode a payload portion is transmitted with a header having a second length that differs from the first length.

33. The transceiver of claim 17, wherein said packets are encoded and demultiplexed for simultaneous transmission using a plurality of transmit branches over the same channel bandwidth.

34. The transceiver of claim 17, wherein said packets are modulated using QAM modulation techniques.

35. The transceiver of claim 17, wherein said packets are modulated using fast Fourier transform modulation techniques.

36. A transceiver for transmitting a plurality of packets over a plurality of antennas at substantially the same time over substantially the same frequency band, comprising:
a transmission mode selector that selects between at least two transmission modes, wherein in the first transmission mode the transceiver transmits said plurality of packets over N antennas at a data rate, R, and wherein in the second transmission mode the transceiver transmits said plurality of packets using at least one of (i) a number of antennas less than N, and (ii) a data rate less than R.

37. The transceiver of claim 36, wherein said transmission mode selector selects one of said transmission modes based on a length of at least a portion of a packet to be transmitted.

38. The transceiver of claim 36, wherein said transmission mode selector selects one of said transmission modes by comparing the length of the at least a portion of the packet to be transmitted to one or more thresholds, each threshold corresponding to one of said transmission modes.

39. The transceiver of claim 36, wherein said transmission mode selector determines a number of antennas to use for transmitting a signal based upon said selected transmission mode.

40. The transceiver of claim 36, wherein said transmission mode selector selects a data rate to use for said transmission.
